(19) United States
(12) Patent Application Publication
(10) Pub. No.: US 2007/0210162 A1
(43) Pub. Date: Sep. 13, 2007

(54) Data storage devices

(76) Inventors: Ian John Keen, Hampshire (GB); Marc Adrian Borrett, Dorset (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/582,167

(22) PCT Filed: Dec. 8, 2004
(86) PCT No.: PCT/GB04/05179

§ 371 Date: May 29, 2007

(30) Foreign Application Priority Data
Dec. 8, 2003 (GB) 0328395.9
Sep. 10, 2004 (GB) 0420159.6

(51) Int. Cl. G06K 7/08; G06F 17/00

(52) U.S. Cl. 235/451; 235/375

(57) ABSTRACT

A data storage device communicates wirelessly with a reader. The data storage device has a data store for storing data and a hidden PIN data store for storing identification data. A controller of the data store has the ability to write identification data to the hidden PIN data store. The controller controls operation of the data storage device in accordance with the outcome of a comparison between identification data stored in the hidden data store and identification communicated to it by a reader. The controller may enable the identification data stored in the hidden PIN store to be replaced or supplemented, in the event that a reader communicating with the data storage device provides to the data storage device identification data that has a predetermined relationship with, for example matches, the identification data stored in the hidden PIN data store.

This invention relates to data storage devices, in particular data storage devices that are designed to communicate wirelessly with a reader.

In particular, this invention relates to data storage devices designed to communicate by radio frequency communication such as RFID (radio frequency identification) or NFC (near field communication) data storage devices.

Generally, at least one of the data storage device and the reader will be portable. For example, the data storage device may comprise or be part of an access card, such as an access card or a ticket, for example a train or bus ticket to a controlled or secure area, and the reader may be provided at the entry to the controlled area. As another possibility the data storage device may be incorporated into advertising materials such as a poster or into point of sale material such as sales tickets and the like and the reader may comprise or be part of a personal portable communications device or other handheld reader. In either case, a number of different readers may come within communication range of a particular data storage device or vice versa. Even where standard communications protocols are used, different readers and data storage devices may operate differently and there is a danger that, if a reader that was not designed for use with a particular data storage device does establish communication with that data storage device, then the data communication may be corrupted, faulty or incorrect data may be written to the data storage device by the reader and/or the reader may respond incorrectly to the data read from the data storage device. For these reasons, it is necessary to ensure that only readers and data storage devices that were designed to communicate with one another can actually communicate with one another. In addition, where a data storage device carries information which is intended to be kept secure or confidential, there is a need to ensure that data from that data storage device can only be read by an authorised reader.

Various identification systems are set out in International standards. For example, ISO14443A requires that ISO14443 data storage devices or tags respond to a first wake up instruction (REQA) with an ATQA “response” to ensure that only ISO14443 data storage devices with the correct communication protocol can respond to ISO144443 readers.

GB-A-2350021 describes a data transponder with plural memory storage areas for use with different types of interrogator or reader. Each memory storage area can only be accessed by a reader or interrogator that communicates the correct key signal or identifier. This ensures that a particular reader can only access the memory storage area that is provided for that reader. The key signal is fixed within the data storage device or transponder. Accordingly, the data storage device or transponder can only work with a fixed set of readers.

WO02/091284 describes a transponder system in which an interrogator or reader has a station identification signal (SIDB) which is unique to the reader and a transponder or data storage device stores the SIDB for the reader with which the data storage device is designed to communicate. Upon receipt of a communication from a reader, a data storage device checks the received SIDB against its stored SIDB. When communication is terminated by one interrogator, the transponder stores a flag to that effect in its memory so that it can no longer communicate with the interrogator which terminated communication but can communicate with other interrogators. As set out in WO02/091284, this enables the transponder successively to enter into communication with different communication stations, for example where the transponder is in the form of an admission pass and is carried by a person who wishes to pass through a number of secured doors in succession, or where the data storage device is carried by an item of baggage or luggage and is transported via baggage conveyor belts with multiple baggage branches each associated an interrogator.

EP-A-00256816 describes a system in which an identification code stored in an identification memory of a response unit is radiated by an identification transmitter only if an opening code radiated by an interrogation unit and an opening code stored in the response unit agree.

U.S. Pat. No. 5,517,188 describes a programmable identification apparatus which includes a transceiver or reader and a transponder or data storage device. The transponder is powered by energy from a transceiver transmit signal and includes a programmable memory element storing a coded sequence which uniquely identifies the transponder. When the transponder is powered by a signal received from the transceiver, the transponder generates a transponder signal which includes the coded sequence stored in its programmable memory. This enables the transceiver to identify the transponder. When the transceiver has thus identified the transponder, the transceiver may communicate a control code to the transceiver that enables the current coded sequence stored in the programmable element to be erased and a substitute coded sequence stored. In the system described in U.S. Pat. No. 5,517,188, the transponder thus communicates its stored coded sequence to the reader so that any reader capable of communicating with the transponder can access that stored coded sequence.

In one aspect, the present invention provides a data storage device such as an RFID data storage device or tag or an NFC data storage device or tag that is arranged to store but not communicate identification data and is programmable so as to enable the identification data to be replaced or supplemented by further identification data received from a reader in the event that identification data having a predetermined relationship with, for example matching, the currently stored identification data is received from that reader.

In one aspect, a data storage device embodying the invention has an identification data storage means, writing means that enable writing of identification data to the identification data storage means, extracting means for extracting identification data from a wireless communication to the communication means, comparing means for comparing identification data extracted by extracting means with identification data stored in the identification data storage means; and control means for controlling operation of the data storage device in accordance with the outcome of the comparison carried out by the comparing means.

A data storage device embodying the present invention enables the identification data within the data storage device to be changed or supplemented without communication from the data storage device of its current identification data. Accordingly, only readers which have been provided with the identification data independently of the data storage device can change or supplement the identification data of the data storage device. Thus, the data storage device effectively controls its own operability, in particular the data storage device controls the readers with which it will operate.

In a data storage device embodying the present invention, the identification data need not be preset or fixed but can be modified by any reader that has the authorisation to change or supplement the identity data of that data storage device. This provides advantages during manufacture of such a data storage device because it means that a manufacturer may make batches of data storage devices that all have the same default or initial identification data, thereby reducing the manufacturing costs. Any person within the chain from the manufacturer to the final end user who has the authority to change or supplement the identification data, that is who has a reader which has separate or independent access to the default identity data, may then cause the data storage device to be customised to a specific application or to a specific user by causing their reader to communicate both any default identification data and replacement or supplemental identification data to the data storage device. In all such circumstances, the data storage device controls whether or not the replacement or supplemental identification data is stored in its memory because the data storage device will only accept the replacement or supplemental identification data once it has confirmed that the default identification data communicated by the reader has a predetermined relationship with, for example matches, the default identification data currently stored in its memory.

One or more of the persons in the chain from the manufacturer to the end user may again replace or further supplement the identification data so as to provide a greater level of security or a greater level of uniqueness for the particular data storage device. Thus, the original manufacturer may supply different sets of data storage devices with different initial identification data to different intermediaries. Such an intermediary may, dependent upon the application for the data storage devices, subdivide their set of data storage devices by replacing or supplementing the identification data stored by the manufacturer and so on, depending upon the use of the data storage device. Where a data storage device is intended to be personal to a particular end user, then the end user may replace or supplement the currently stored identification data with their own personal unique identification data so that only they can access data stored by the data storage device.

A data storage device embodying the invention may be a self-contained device. For example, such a data storage device may be incorporated into paper or other media which may take the form of, for example, a security pass, an access ticket such as a bus or train ticket, promotional or advertising literature, for example a poster advertising a CD or DVD, point-of-sale material such a sales ticket and shelf labels.

One or both of a data storage device and a reader may be incorporated into a larger device or system, for example, a mobile telephone (cellphone), PDA (personal digital assistant) computer or other electrical or electronic device. For example, one of the data storage device and the reader may be incorporated into an accessory, component or housing portion of a larger device or system and the other of the data storage device and the reader may be incorporated into another component, accessory or housing portion of that device or system, or may be stand alone or incorporated in to a different larger device or system.

In some embodiments, a data storage device embodying the invention may be incorporated in a larger device or reader which can act either as a reader of such data storage devices or as a data storage device, for example the larger device may be or incorporate an NFC device.

In a data storage device embodying the invention, the identification data (for example a PIN (personal identification number) code, code, key, signature, formula, algorithm or any other data that can be used to identify the device) programmed into the data storage device determines whether communication of data with a reader in range of the data storage device is permitted by that data storage device. The PIN code may also be generated by a security device such as an EMV (Europay MasterCard Visa) device within the data storage device and any relevant reader. Thus, the data storage device itself controls whether it communicates data to and/or receives data from a reader within range of data storage device. Similarly, where a communications device has both data storage device and reader functionality, when the communications device operates as data storage device, the identification data programmed into the data storage device of the communication device controls operation of that data storage device and for example controls whether or not another reader (which may itself also incorporate a data storage device) can read data from and/or write to that data storage device.

The data storage device may be a radio frequency identification (RFID) data storage device or tag or may be a near field communication (NFC) device or tag. In either case, the device may or may not also have reader functionality as discussed above. The data storage and reader functionality may or may not be incorporated into a single circuit component for example a single semiconductor chip.

A data storage device embodying the invention may be an active data storage device that has its own power source, generally an internal battery, or a passive data storage device which has no internal power source and which derives its power supply from an externally supplied signal, generally a signal provided by the reader.

Generally, communication of commands and data between the reader and the data storage device is effected by modulation of an RF (radio frequency) signal. The modulation may be any known form of modulation, for example amplitude, frequency or phase modulation. Generally, the RF signal will be a 13.56 MHz RF signal. The RF signal could, however, be any suitable RF signal, for example an RF signal that uses an unlicensed frequency or frequency band. Thus, as other examples, the RF signal could be a 125 KHZ signal, a 433 MHZ signal or a UHF signal. The data storage device may achieve this modulation by changing the load on an RF signal received from the reader or may modulate an internally generated RF signal. Communication of data may also be effected by modulation arising during interaction or interference between respective signals supplied by the reader and the data storage device.

A data storage device embodying the invention enables flexibility in the setting of identification data. The identification data may be changeable by any person in the chain from the manufacturer to the end user who has authority to do so, that is who has a reader that is or that can be provided with the current identification data of the data storage device. The operability of a data storage device embodying the invention is thus determined by the data storage device itself which enables the data storage device to control which readers it will operate with rather than vice versa. This is particularly useful where the end user can replace or supplement the identification data with his own personal identification data because it means that the end user can control the readers with which he wishes to communicate. In addition, it is not necessary to manufacture the data storage device so that it has preset memory areas accessible by preset readers. Rather, a data storage device embodying the invention can be programmed so that the data storage device controls whether it communicates with one specific reader, one particular type of reader or a number of different types of readers. This and the fact that many different data storage devices can be manufactured in the same process and then differentiated by programming the identification data, facilitates simplicity, flexibility and enhanced security for the end user with little, if any, additional manufacturing costs because, for example, there should be little, if any increased semiconductor (generally silicon) real estate requirements costs over data storage devices not having this enhanced functionality.

An embodiment of the present invention provides a data storage device which can be programmed with identification data such as a PIN code at various stages in the manufacturing and supply chain. An embodiment of the present invention provides a data storage device that ensures simplicity, flexibility and little, if any, additional manufacturing costs in terms of increased semiconductor area required to enable the enhanced security for the end user of such data storage devices.

The data stored by the data storage device may be any suitable form of data, examples being an instruction or instructions, control signal data, program code data, data representing text, audio data such as a WAV file, image data video data, which data may or may not be in compressed form.

Embodiments of the present invention will now be described, by way of example, with reference to the accompanying drawings, in which:

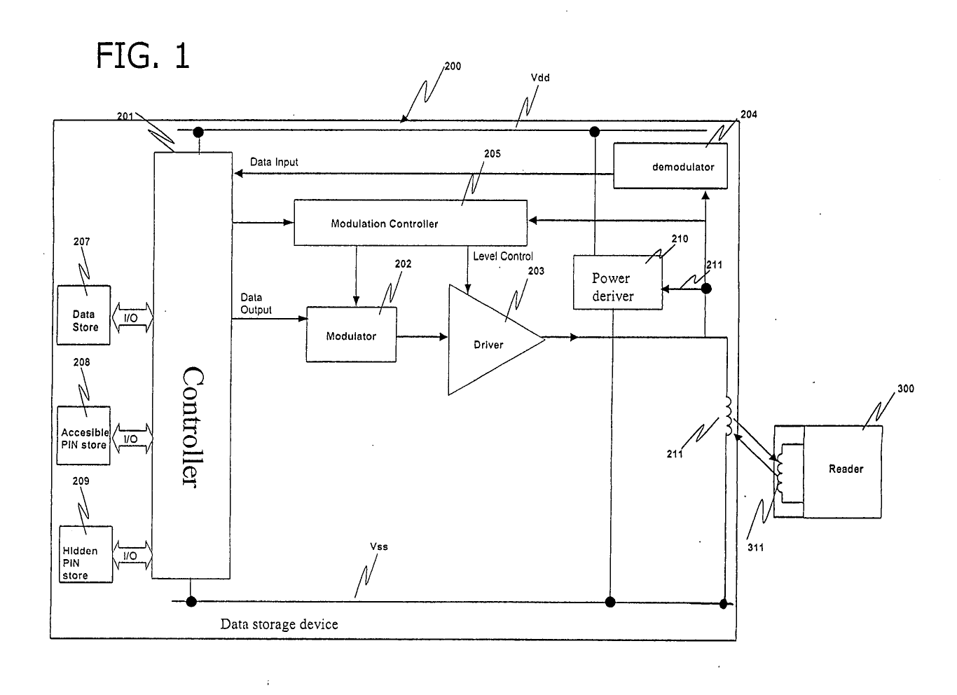

FIG. 1 shows a functional block diagram illustrating one embodiment of a data storage device in accordance with the invention;

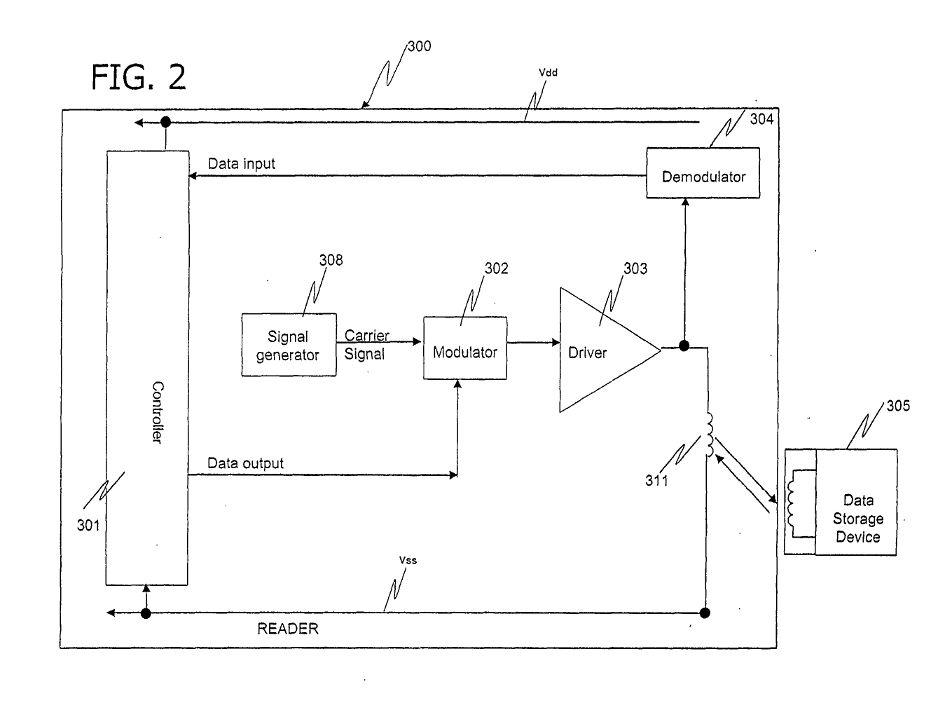

FIG. 2 shows a functional block diagram illustrating of one embodiment of a reader suitable for reading the data storage device shown in FIG. 1;

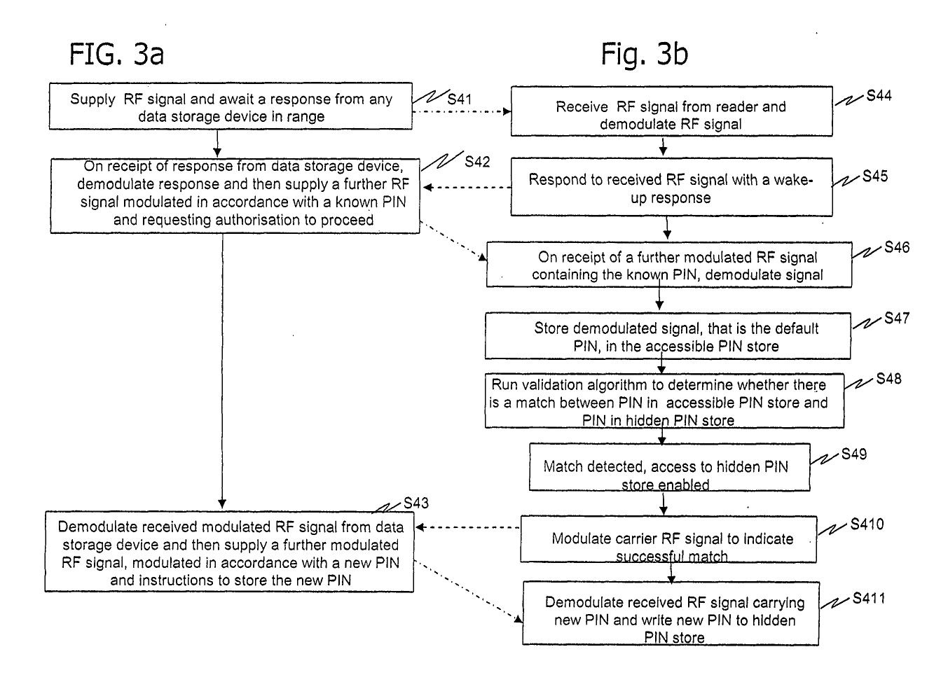

FIG. 3 shows a flowchart illustrating one method of replacing or supplementing identification data stored by the data storage device shown in FIG. 1;

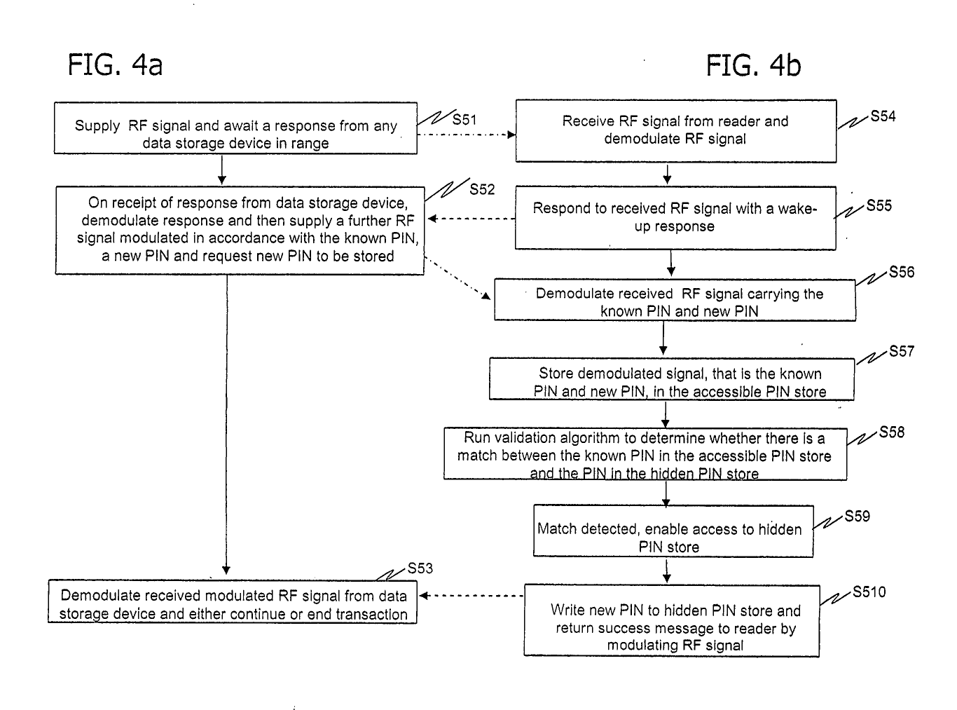

FIG. 4 shows a flowchart illustrating another method of replacing or supplementing identification data stored by the data storage device shown in FIG. 1;

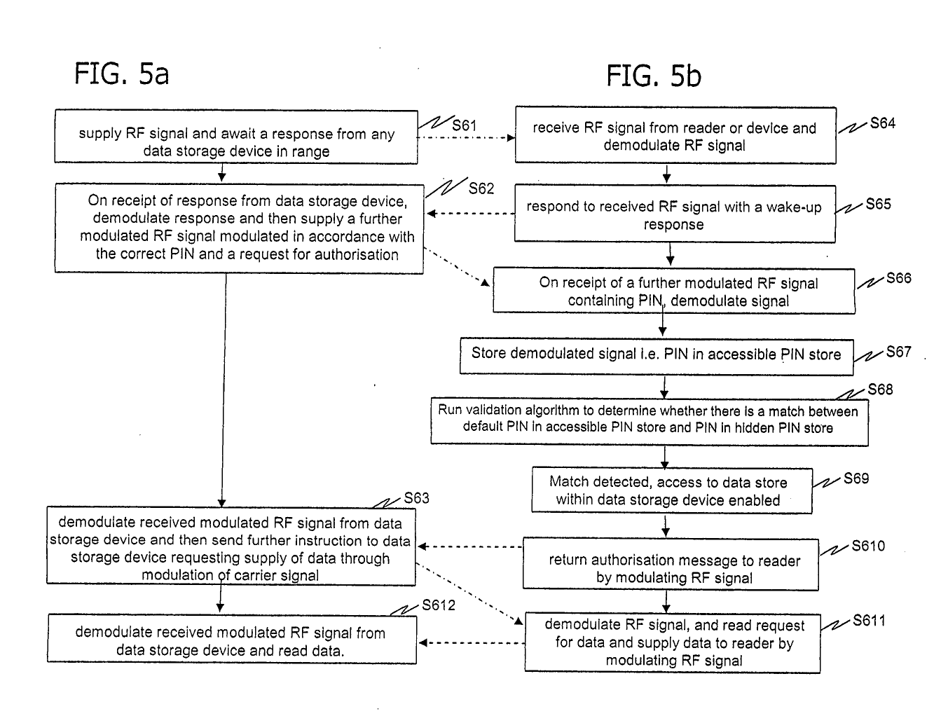

FIG. 5 shows a flowchart illustrating communication between the data storage device shown in FIG. 1 and the reader shown in FIG. 2;

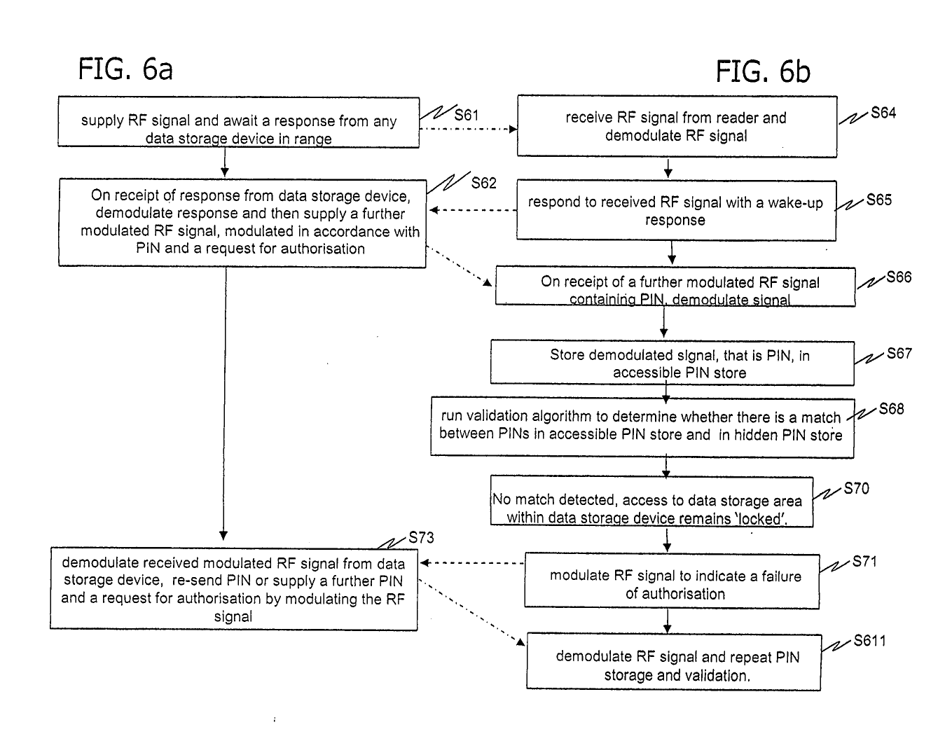

FIG. 6 shows a flowchart illustrating failed communication between the data storage device shown in FIG. 1 and the reader shown in FIG. 2;

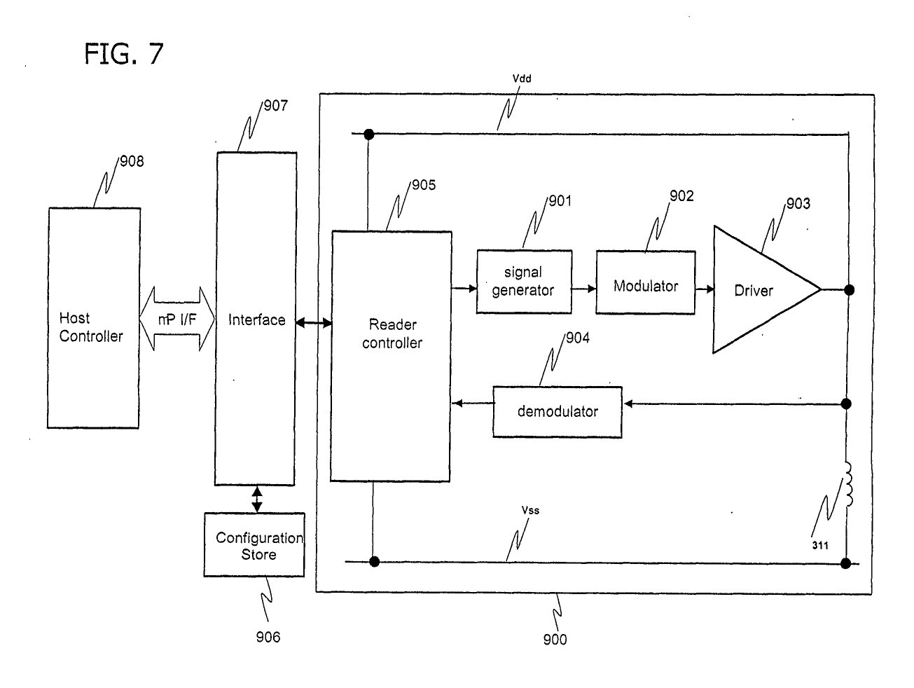

FIG. 7 shows a functional block diagram of a larger device or apparatus incorporating the reader shown in FIG. 2; and

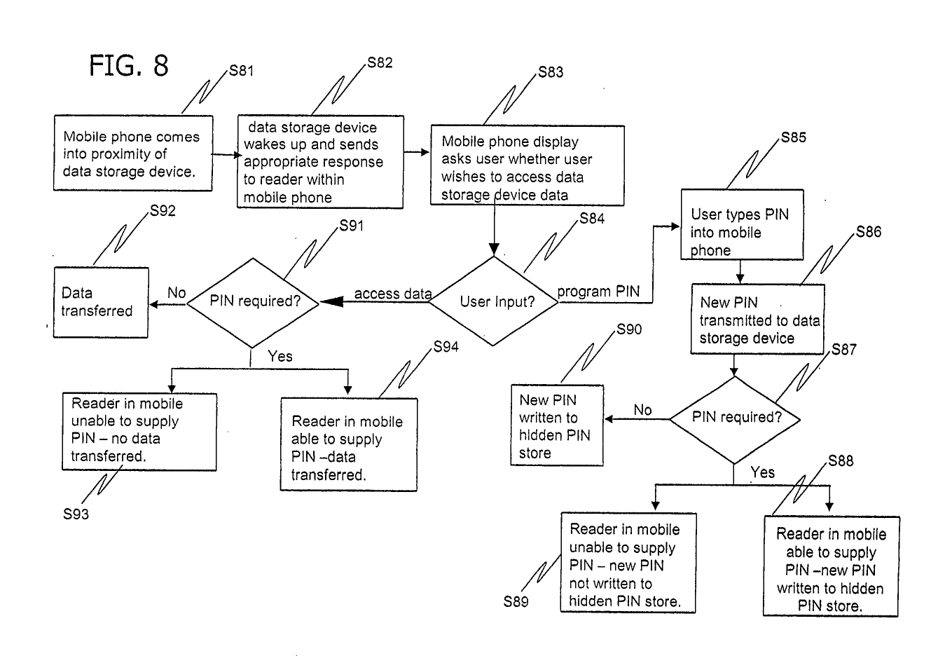

FIG. 8 shows a flowchart illustrating how the identification data stored by the data storage device shown in FIG. 1 may be replaced or supplemented using the apparatus or device shown in FIG. 7.

Referring now the drawings, FIG. 1 shows a functional block diagram illustrating the main components of one example of a data storage 200 embodying the invention while FIG. 2 shows a functional block diagram illustrating the main components of one example of a reader 300 suitable for reading data from the data storage device 200.

It will, of course, be appreciated that the Figures are not to scale and that the data storage device 200 and the reader 300 are shown enlarged in FIGS. 1 and 2, respectively, to enable illustration of their functional components.

The data storage device 200 and reader 300 may be stand alone separate components, or may be integrated, embedded, or otherwise incorporated into a product such as ticket, pass etc or a larger device or a part or an accessory of a larger device. The larger device may be, for example, a consumer electrical or electronic device or appliance, for example a mobile telephone (cellphone) or PDA. As other possibilities, the larger device may be an industrial, commercial or medical item which may or may not be portable, for example the larger device may be an item such as a fire extinguisher or a medical device or medicines container. For example, at least one of the data storage device 200 and the reader 300 may form part of a consumer electrical or electronic device such as a mobile telephone or a PDA, for example the part may be a housing portion such as a fascia, an accessory such as a keyboard or other input device. In addition, any such device may incorporate both a data storage device 200 and a reader 300 and be operable in a first mode in which the device acts as a data storage device and can communicate with other readers and a second mode in which the device acts as a reader and can read other data storage devices. This combined device may or may not have functionality other than the ability to function as a data storage device in one mode and a reader of such a device in the other mode. Where the data storage device and/or reader is incorporated within a larger device, then the functionality of the data storage device and/or the reader may be provided as a discrete independent unit within the larger device or alternatively may use parts of or form part of the circuitry already existing in that larger device.

Referring firstly to FIG. 1, the data storage device 200 is, in this example, a passive data storage device, that is the data storage device is not self-powered. Rather, the data storage device derives power from an externally supplied signal, in this case a radio frequency RF signal supplied by the reader 300 when it is in range.

The passive data storage device may be an RFID (radio frequency identification) data storage device (sometimes known as a “tag” or transponder) or a near field communications (NFC) device.

As shown in FIG. 1, the data storage device 200 has a controller 201 in the form of a microcontroller or microprocessor that controls the overall operation of the data storage device.

The controller 201 is associated with a data store 207 that stores data to be communicated to a reader 300. As the data storage device 200 is a passive data storage device, the data store 207 should consist of non-volatile memory so that the content of the data store 207 is not lost when the data storage device 200 is not powered. The data storage device 200 may be designed so that the content of the data store 207 is fixed and cannot be changed. In this case, the data store 207 will generally comprise read only memory (ROM). Alternatively, the data storage device 200 may be configured so that data can be written to the data store 207 in which case the data store 207 will comprise writable non-volatile memory. The data store 207 may have non-writable and writable memory portions.

Where the data store 207 has a non-writable portion, then that portion of the data store 207 may be provided by mask ROM in which custom metal mask layers are used to define the data stored or by write once read many (WORM) or one time programmable (OTP) memory which may consist of electrically erasable programmable read only memory (EEPROM) which, after programming, has the erase function disabled (for example by using an electrical current to fuse a fuseable link) so that the signals required to program the EEPROM can no longer be provided. As another possibility, an OTP functionality can be achieved by use of electric current to melt and physically destroy a metal or polysilicon metal link to open circuit a connection and irreversibly fix the logic state of each individual bit in the memory.

In addition to the data store 207, the controller 201 is associated with a writable PIN data store 208 and a hidden PIN data store 209 both for storing identification data.

As will be explained below, the writable PIN data store 208 effectively provides a working memory for identification data or a PIN code received from a reader 300 while the hidden PIN data store 209 provides the identification data store.

The nature of the writable PIN data store 208 will depend upon the precise functionality required for the data storage device 200. Thus, where tracking of the changes of the identification data or PIN code is not required, then the writable PIN data store may be provided by volatile memory such as random access memory (RAM) so that, in the case of the passive data storage device being described, the content of this memory is lost when the device is no longer powered. Alternatively, where it is required or desired to retain a history of the PIN data, then the writable PIN data store 208 will consist of non-volatile memory. Generally, this non-volatile memory will be memory that can be written to many times such as EEPROM. If, however, an application requires that the PIN can be changed only once then, of course, the hidden PIN data store 209 will be configured as write once or one time programmable memory. The hidden PIN data store 209 is provided by non-volatile writable memory which is configured so that the data stored within the hidden PIN data store 209 cannot be accessed other than by the controller 201 of the data storage device 200, that is the data stored in the hidden PIN data store 209 cannot be accessed by a reader 300 communicating with the data storage device 200. In this example, the hidden PIN data store 209 is formed as write only memory (WOM). This may be implemented as EEPROM in which the associated address decoding and control logic is permanently set to prevent any external reading functions so that the data stored in the hidden PIN data store 209 can only be accessed by the controller 201. The address decoding and control logic of the hidden PIN data store 209 may also include logic that ensures that writing operations are allowed to the hidden PIN data store 209 only under certain control conditions.

The data storage device 200 thus has a data store 207 for storing data to be communicated to a reader 300 a writable PIN data store 208 for storing identification data received from a reader 300 and a hidden PIN data store 209 which cannot be accessed by the reader for storing the current identification data of the data storage device 200.

As shown in FIG. 2, the reader 300 comprises a controller 301 which may again be in the form of a microprocessor or microcontroller and, although not shown in FIG. 2, will generally also have associated memory. The reader 300 has a signal generator 308 configured to output an RF signal. The RF signal is supplied via a modulator 302 and a driver or amplifier 303 to an antenna or inductive coupler which is shown in FIG. 2 simply as a coil 311. The modulator 302 is coupled to a data output of the controller 301 to enable the RF signal supplied by the signal generator 308 to be modulated, or not, in accordance with data supplied by the controller 301. In this example, the reader 300 provides a 13.56 MHz frequency signal modulated in accordance with any data supplied by the controller 301 to the modulator 302.

Although not shown in FIG. 2, the reader 300 of course requires a power supply for power supply rails Vdd and Vss. This power supply will generally be a battery where the reader is designed to be portable and stand alone. Of course, where the reader is designed to be fixed in position, then a mains-derived-power supply may be used. Similarly, where the reader is incorporated in a larger device, then the reader may derive power from the power supply of that larger device, for example a mobile telephone battery where the reader forms part of the mobile telephone. In the interests of simplicity, the coupling of the functional components to the power supply rails Vdd and Vss are not all shown in FIG. 2.

The data storage device 200 has an antenna or inductive coupler again shown simply as a coil 211 so that, when the reader 300 and data storage device 200 are in range of one another (for example 0 to 20 cm for NFC, in the region of a few centimetres for RFID and in the region of 1 to several metres for UHF), the RF signal produced by the reader 300 is inductively coupled into the data storage device 200. The data storage device 200 has a demodulator 204 which serves to extract any modulation from the RF signal inductively coupled to the data storage device 200 and to provide a digital data output to a data input of the controller 201.

The data storage device 200 has a power deriver 210 coupled between first and second power supply rails Vdd and Vss which derives a power supply from the RF signal inductively coupled to the data storage device. Again, in the interests of simplicity, the couplings of the functional components of the data storage device 200 to the power supply rails Vdd and Vss are not all shown in FIG. 1.

A data output of the controller 201 of the data storage device is coupled to a modulator 202 and a amplifier/driver 203 to enable an RF signal inductively coupled to the data storage device to be modulated in accordance with data output from the data output of the controller 201.

The data storage device 200 may additionally include a modulation controller 205 for controlling the amplitude of the modulated RF signal, for example altering the gain of the driver/amplifier 203, in accordance with instructions received from the controller 201 in response to characteristics of the data input signal determined by the proximity of the reader 300 or other characteristics of the received RF signal.

The reader 300 has a demodulator 304 for extracting any modulation of the coupled RF signal by the data storage device 200 and for providing a digital data signal to a data input of the controller 301.

Any suitable form of modulator, amplifier/driver, data receiver and modulation controller may be used as known by those skilled in the art. For example, as described in, for example WO02/052419 or WO98/24527 the modulators 202 and 302 may comprise switches such as field effect transistors with the data output of the controller being coupled to control gate of the transistor, while the demodulators 204 and 304 may be simple diode rectifiers. The power deriver 210 may comprise two series-connected diodes coupled between the power supply rails Vdd and Vss with the junction between the two diodes being coupled to the inductive coupler or antenna 211.

As set out above when the data storage device 200 and reader 300 are in range of one another and the reader 300 generates an RF signal, the power deriver 210 of the data storage device 200 will derive a power supply from the received RF signal. Subsequent operation of the data storage device and the reader will depend upon the particular communications protocol with which the data storage device 200 and reader comply. The communications protocol may determine the type of modulation for example (amplitude, phase or frequency) and may also determine the nature and type of at least some of the control codes communicated between the reader and the data storage device. Other control codes communicated between the reader and the data storage device may, of course, be determined by the specific programming of the controllers 201 and 301. For example, the controller 301 of the reader may cause the RF signal to be modulated with a “wake up” instruction (sometimes known as an “REQA request”) designed to activate the data storage device in a particular fashion. The demodulator 204 of the data storage device will extract this instruction from the received RF signal and the controller 201 will respond in accordance with the protocol with which the data storage device and reader comply and in accordance with its programming and the data stored in its data store.

In a first example, the hidden PIN data store 209 is manufactured so as to contain a default PIN code or identification data, for example zero or a string of zeros.

FIG. 3 illustrates one way in which a new PIN code may be stored in the hidden PIN data store 209 of the reader 300. FIG. 3a shows the steps carried out by the reader 300 while FIG. 3b shows the steps carried out by the data storage device 200. The dot-dash lines in FIG. 3 illustrate communication from the reader 300 to the data storage device 200 and the dashed lines indicate communication from the data storage device 200 to the reader.

Thus, in order to store a PIN code into the data storage device, at S41, the reader 300 supplies an RF signal modulated in accordance with the communications protocol under which the reader and the data storage device operate and awaits a response from any data storage device in range.

When, at S44, a data storage device 200 receives the RF signal from the reader, it demodulates the RF signal to extract the instructions carried by the RF signal and responds at S45 to the received RF signal with a “wake up” response.

At S42, the reader 300 receives the “wake up” response from the data storage device 200 and the demodulator 304 demodulates the response to extract the data carried by the RF signal. The controller 301 of the reader then checks the received data to see if the response is correct, that is that the data storage device complies with the communications protocol under which the reader and data storage device operate, for example whether the data storage device is an RFID device operating under the ISO14443A protocol or an NFC device operating under the NFCIP-1 (ISO 18092) or NFCIP-2 (ISO 21481) protocol. This initial checking procedure ensures that only readers and data storage devices operating on the same communications protocol can communicate.

Assuming that the data storage device 200 has responded correctly, then at S42 the reader 300 supplies a further RF signal modulated in accordance with a known PIN code and a request for authorisation to proceed. The known PIN code is a PIN code independently provided to the reader 300 and is in this example, a default PIN code allocated to all such data storage devices during manufacture.

At S46, the data storage device 200 demodulates the received further modulated RF signal containing the known PIN code and at S47 stores the modulated data as a received PIN code in the writable PIN data store 208.

Then, at S48, the controller 201 of the data storage device 200 runs a validation algorithm to determine whether there is a predetermined relationship between the known PIN code received from the reader 300 and stored in the writable PIN data store 208 and the PIN code stored in the hidden PIN data store 209.

An example of a validation algorithm that may be used by the controller 201 to determine whether there is a match between the identification data is as follows:

```
Try = Try + 1
IF Input_PIN = Hidden_PIN
  THEN Enable_Bit = True
    Try = 0
  ELSE Enable_Bit = False
IF Try = 10
  THEN Lock_Tag_Forever = True
```

The step “if input_pin=hidden_pin” will generally involve comparing each bit of the input PIN against the corresponding bit of the hidden in turn and a match will be determined only if each bit of the input PIN is the same as the corresponding bit of the hidden PIN.

The above algorithm determines whether there is a match between the identification data. The algorithm may, however, determine a different form of predetermined relationship between the identification data. For example the algorithm may determine whether one of the received identification and the stored identification data is the inverse of the other or is related to the other by a predetermined function, equation or algorithm. As another example, one of the received identification and the stored identification data may be a function, equation or algorithm that enables determination of the other. As an example, the received and stored identification data may enable a public-private key system

If, at S49, the controller 201 determines that the received PIN and the hidden PIN match, then at S410, the controller 201 of the data storage device 200 modulates the RF carrier signal with data indicating that a successful match has occurred. At this stage, the controller 201 also enables write access to the hidden PIN data store 209, for example by setting a write enable bit in the hidden PIN data store 209 or in the controller 201.

At S43, the reader 300 demodulates the received RF signal indicating a successful match and then supplies a further modulated RF signal carrying a new PIN code and instruction to write the new PIN code to the hidden PIN data store.

Upon receipt at S411 of the further modulated RF signal, the demodulator 204 demodulates the received RF signal carrying the new PIN code and the controller 201 causes the new PIN code to be written to the hidden PIN data store 209.

FIG. 4 shows another way of changing the PIN code of the data storage device. As in FIG. 3, FIG. 4a shows the steps carried out by the reader 300 while FIG. 4b shows the steps carried out by the data storage device 200.

The reader and the data storage device again carry out the initial communication checks required by the protocol. Thus, step S51, S54 and S55 in FIGS. 4a and 4b correspond to S41, S44 and S45 in FIGS. 3a and 3b.

In this example, however, when the reader 300 determines that the response from the data storage device 200 is correct and in accordance with the protocol with which the reader complies, then at S52 the reader 300 supplies a further modulated RF signal modulated in accordance with the known PIN code, a new PIN code and a request for the new PIN code to be written to the hidden PIN data store 209.

The demodulator 204 of the data storage device 200 demodulates the further modulated RF signal at S56 and then at S57 stores the known PIN and new PIN codes extracted from the further modulated RF signal in the writable PIN data store 208.

Then, at S58, the controller 201 runs a validation algorithm as described above to determine where there is a predetermined relationship between the known PIN code in the writable PIN data store 208 and the PIN in the hidden PIN data store. If a predetermined relationship is detected at S59, then the controller 201 enables writing access to the hidden PIN data store, for example (by setting a write enable bit in the hidden PIN data store) and at S510 writes the new PIN code to the hidden PIN data store and returns a success message to the reader by modulating the RF signal.

At S53, upon receipt of the modulated RF signal indicating successful writing of the new PIN code, the reader 300 either continues with further communication, for example to enable reading of data from or writing of data to the data store 207, or ends the transaction.

Thus, the method described above with reference to FIGS. 4a and 4b differs from the method described above with reference to FIGS. 3a and 3b in that, in the method in FIGS. 4a and 4b the known and new PIN code are supplied in the same step.

Thus, data storage devices embodying the invention have the flexibility that any person having a compatible reader and independent knowledge of the PIN code or password stored in the hidden PIN data store 209 can request storing of a replacement PIN code and whether or not replacement of the PIN code is effected will be controlled entirely by the data storage device.

As described above, a data storage device embodying the invention is manufactured so as to contain an initial default value. Ensuring that the hidden PIN 209 contains a PIN code on manufacture means that only subsequent readers that have been provided with the manufacturers default PIN code can request the data storage device to change its hidden PIN. It is, however, possible that the data storage devices may be manufactured without a hidden PIN code so that an activation device can be used to input a PIN code after manufacture or the first time a reader requests storage of a PIN code in the hidden PIN data store, the reader does not have to send a known PIN code. However, once the hidden PIN data store 209 contains a PIN code, any reader attempting to change the PIN will need to have independent knowledge of the hidden PIN code.

The ability to change the PIN code means that, for example, suppliers and distributors downstream of the manufacturer may change the hidden PIN number to provide additional security so that even the original manufacturer does not have access to that hidden PIN code by carrying out the procedure shown in FIG. 3 or 4, provided that they or their reader knows the current PIN code. Similarly, the end user may change the hidden PIN code so that only he has access to that hidden PIN code.

The manner in which the hidden PIN code affects the operation of the data storage device 200 will be determined by the programming of the controller 201 of the hidden storage device. For example, the controller 201 may be programmed so that a reader 300 can only access the data stored in the data store 207 if the reader 300 supplies a PIN code which has a predetermined relationship with the PIN code stored in the hidden PIN data store 209. As another possibility the data store 207 may be divided into secure and non-secure areas and the controller 201 may allow access to the non-secure area without receipt of a PIN code but only allow access to the secure area when the reader supplies the correct PIN code. As another possibility or additionally, where the data storage device 200 is configured so as to enable data stored in the data store 207 to be overwritten or supplemented, then the controller 201 may be programmed only to allow a reader to replace or supplement the data in the data store 207 upon receipt of the hidden PIN code. Other aspects of the functionality of the data storage device available to a particular reader may be controlled by the controller 201 in accordance with whether or not the reader supplies the hidden PIN code.

As so far described, there is a single hidden PIN code. It will, however, be appreciated that there may be more than one hidden PIN code. For example, in the case of the chain from the manufacturer to the end user, each entity within the chain may, instead of replacing the current hidden PIN code with their own PIN code, supplement the current hidden PIN code with their own PIN code so that, subsequent to the supplementing of the code, different levels of security are provided. This may be achieved by storing a series of different PIN codes in the hidden PIN data store 209 or simply by generating a larger PIN code by combining the individual PIN codes. Where such different levels of security are provided, then the controller 201 may be programmed so that different levels of security are required to access different areas of the data store 207 or different aspects of the functionality of the controller 201. Thus, for example, the controller 201 may be programmed to allow any reader meeting the communications protocol requirements to access a non-secure area of the data store 207, to allow only the manufacturer to access a first restricted area, to allow only an intermediate supplier to access a second further restricted area and to allow the end user to access a third further restricted area. Where individual PIN codes are stored for the different entities that may be involved with the data storage device, then those different entities may also have access to different aspects of the functionality of the data storage device so that, for example, a manufacturer may be able later to access an area related to the programming of the data storage device while an intermediate supplier or an end user cannot.

PIN codes may also be associated with different modes of operation or the use of different communication protocols so that, for example, the controller 201 may be programmed to operate in accordance with any one of a number of selected communications protocols with the actual communication protocol used being determined by the PIN code supplied by the reader. For example, the data storage device may be configured to operate using one communications protocol if no PIN code is supplied or another communications protocol (which may be more secure for example) if the correct PIN code is supplied. As another possibility, the hidden PIN data store 209 may store a number of different PIN codes for different communication protocols and the controller 201 may be programmed to operate in accordance with the protocol associated with the one of the hidden PIN codes that has a predetermined relationship with the PIN code supplied by the reader.

As another possibility the data carried by the data storage device 200 could be in the form of software and the data store may store both a demo version of the software which is accessible without the PIN code and a full version of the software which is only accessible with the PIN code and a user of the reader or a larger device incorporating the reader such as a mobile telephone may gain access to the full version of the software by purchasing a licence from a supplier of the software who will then supply the correct PIN code to cause the controller 201 to allow that software to be downloaded. The correct PIN code may be supplied to the user or user's reader or may be supplied directly to the data storage device so that neither the user or the user's reader knows the PIN code. This facility could also be used to supply, for example, ring tones and the like for mobile telephones

As so far described, it has been assumed that the PIN code stored in the hidden PIN data store 209 may be replaced or modified or added to many times. There may, of course be applications where it is desirable for the hidden PIN data store 209 to be configured so that it can be written to only once so that a default initial or zero PIN code can only be replaced once.

As is evident from the description of FIGS. 3 and 4 above, in order to request the change of a PIN code of a data storage device, the reader 300 includes an appropriate change PIN code request instruction in the modulation of the RF signal supplied to the data storage device. The issuance of such a change PIN code instruction or code may be automatic, for example where no PIN code is preset into the data storage device or the data storage device has a generic or default PIN code, then the communication protocol may require the setting of a PIN code before any further transactions can occur. Alternatively, the issuance of the PIN code change request instruction may be controlled by a user of the reader, for example the manufacturer, intermediate distributor or supplier or end user as described above, by inputting of an instruction to the reader 300. Such an instruction may be supplied to the reader 300 by means of an RF modulated signal from another device, for example another reader or from part of a larger device within which the reader is incorporated or a service provider with which the reader can communicate or may be supplied directly from another device or service provider to the data storage device by wireless communication

Where the data storage device can store multiple PIN codes, then, to provide an added level of security, some of the PIN codes may affect the functionality of the data storage device 200 and one or more others of the PIN codes may affect whether or not a reader 300 can change one or more of those hidden PIN codes and different ones or different combinations of the PIN codes may be required to enable the reader to change another PIN code depending upon the particular PIN code that the reader 300 wishes to change so that, where a PIN code provides greater access to functionality of the data storage device, a higher level of security may be provided by requiring the reader to provide a number of other PIN codes as an authorisation code. In such a case, when the controller 201 receives a request from a reader to change a PIN code, the reader will need to send of its own accord or in response to a request from the data storage device the one or more PIN codes that the controller requires to authorise a PIN code change request. In this case, the controller 201 will carry out the validation procedure described above on the authorisation PIN codes and only once the reader's authorisation to change a PIN code has been validated will the data storage device check whether or not the data storage device PIN code supplied by the reader has a predetermined relationship with the data storage device PIN code stored in the hidden PIN data store. As another possibility, two or more PIN codes may be supplied and checked at the same time.

FIGS. 5 and 6 are flowcharts illustrating operation of communication between a reader and the data storage device embodying the invention where a PIN code is stored in the hidden PIN data store 209, for example by using the method described above with reference to FIG. 3 or 4. FIGS. 5a and 6a illustrate the operations carried out by the reader 300 while FIGS. 5b and 6b illustrate the operations carried out by the data storage device 200.

FIG. 5 illustrates what happens when the reader 300 provides the correct PIN code.

Thus, at S61, the reader 300 outputs an RF signal and awaits a response from any data storage in range. At S64, a data storage device in range of the reader receives and demodulates the RF signal and then, at S65, responds to the received RF signal with a wake up response in accordance with the protocol with which the communication between the reader and the data storage device are compliant.

At S62, on receipt of the response from the data storage device, the reader 300 demodulates the response, and carries out any required communications protocols checks on the response. The reader 300 then supplies a further RF signal modulated in accordance with the PIN stored in its memory and a request for authorisation.

At S66 the data storage device demodulates the signal containing the PIN code and request for authorisation. At S67, the data storage device 200 stores the demodulated signal, that is the PIN code, in the writable PIN data store 208 and at S68 runs the validation process described above to determine whether the received PIN code stored in the written PIN code store 208 has a predetermined relationship with the PIN code stored in the hidden PIN data store 209.

In this case, the data storage device 200 determines that there is a predetermined relationship and at S69 enables access to the data store 207 or to the area of the data store 207 or functionality of the data storage device 200 to which the PIN code provides access. Then, at S610 the data store returns an authorisation message to the reader 300 by modulating the RF signal.

At S63, the reader demodulates the received modulated RF signal from the data storage device 200 and, having determined that authorisation has been given, sends a further instruction to the data storage device 200 requesting supply of data or a functionality by modulating the RF signal with a data request instruction or code in accordance with the communications protocol. Then, at S611, the data storage device demodulates this RF signal, identifies the request for data and outputs the data from the data store or the area of the data store accessed by the received PIN code to the modulator 202 so as to cause the RF signal to be modulated in accordance with that data. Then, at S612 the reader receives the modulated RF signal, the demodulator 304 extracts the data from the received modulated RF signal and supplies this to the data input of the controller 301. The reader 300 may then terminate the transaction and may process the data in any manner appropriate to the data. For example, the reader may download the data to a user interface associated with the reader or a larger device incorporating or associated with the reader or may reprogram part of the reader or a larger device associated with the reader as a result of the received data, for example to install or modify software being run by the reader or a larger device incorporating the reader.

The enabling of access to the data store (or an area of the data store associated with the PIN code) may be by way of setting an enabling bit within the controller or the data store or that part of the data store and the status of the bit may be checked by the controller 201 in subsequent communications between the reader and the data storage device during the current transaction. The controller, will, in this case reset the data bit after the current transaction with the reader has terminated so that re-supply of the PIN code is required for another transaction.

In any event, if the data storage device and reader for any reason go out of range of one another, access to the data store will be automatically disabled and the content of the writable PIN data store 208 will be erased. In this example, where the data storage device is passive and the writable PIN data store 208 is volatile, the content of the writable PIN data store 208 will automatically be lost when the data storage device powers down.

As described above, the authentication of the PIN code provided by the reader enables the reader to access data in the data store or a part of the data store. As another possibility, the existence of a predetermined relationship between the hidden PIN code and the PIN code provided by the reader may simply allow further communication between the data storage device and the reader, that is may result in resumption of a communications protocol rather than simply the supply of data held in the data storage device.

As set out above, on completion of the transaction of communication between the data storage device and the reader, where the supply of the correct PIN code has caused an enable bit to be set in the data store 207, the controller 201 will reset that data bit at the end of the transaction. Also, as set out above, if the data storage device and reader for any reason go out of range of one another, access to the hidden PIN store will be automatically disabled and the content of the writable PIN data store 208 automatically erased, if the writable PIN data store 208 is formed of volatile memory.

As described above, the data storage device is a passive data storage device which derives its power supply from the reader. Accordingly, at the end of a transaction with the reader, the data storage device will power down. The writable PIN data store 208 is preferably provided as volatile memory (for example RAM) so that the content of this store is automatically erased when the data storage device powers down so that any new transaction with the same or a different reader will again require the supply of a PIN code. As an alternative to providing the writable PIN data store 208 as volatile memory, the writable PIN data store 208 may be provided as programmable non-volatile memory such as EEPROM and the controller 201 may be programmed to erase the content of this memory when the current transaction with a reader is terminated or the data storage device powers down.

The writable PIN data store 208 is, unlike the hidden PIN data store 209, configured so as to be accessible from outside of the data storage device. Accordingly, causing the writable PIN data store 208 to be erased at the end of a transaction ensures that no reader or user can determine the hidden PIN code by reading or otherwise accessing the PIN code stored in the writable PIN data store 208 from the last transaction. There are, however, circumstances in which it may be desirable to maintain a history of the PIN codes that have been stored in the writable PIN data store 208, for example where a data storage device is being tracked through a number of events or procedures and a log indicating each of these events or procedures is required. In such circumstances, the controller 201 will be programmed to store a history of the PIN codes stored in the writable PIN data store 209. This history may, for example, be stored in an area of the data store 207 that is itself protected by a PIN code so that only a user authorised to read this history can have access to this data. In these circumstances, where the writable PIN data store 208 is volatile memory, then the controller 201 will copy the PIN code data stored in the volatile memory 208 to the history data file before the end of the transaction with the reader so that this data is not lost when the data storage device powers down at the end of the transaction

FIG. 6 illustrates operation of the reader and a data storage device embodying the invention when the reader fails to provide the correct password. Steps S61 to S68 are the same as the correspondingly numbered steps in FIGS. 5A and 5B and will not be described again. In this case, however, when the data storage device carries out the validation algorithm, the data storage device determines at S70 that there is no predetermined relationship and accordingly access to the data store 207 or the area of the data store 207 secured by the PIN code is prohibited, that is that data store or data store area remains locked. In this case, at S71, the data storage device modulates the RF signal to indicate a failure of authorisation. When, at S73, the reader demodulates the received RF signal indicating failure of authorisation, the reader may attempt the authorisation procedure again by resending the same PIN code or supplying a further PIN code and again requesting authorisation. In response to such a further request at S72, steps S62 to S68 in FIG. 5 or 6 are repeated. If a predetermined relationship is found, then steps S69, S610, S611, S63 and S612 in FIG. 5 are carried out. However, if a predetermined relationship is not found, then steps S71 to S73 are repeated. The data storage device is preferably configured to allow only a certain number of attempts to supply the correct PIN code and after that set number of attempts, the controller 201 of the data storage device 200 may cause the data storage device 200 to be permanently locked or disabled and the stored data inaccessible. A count of the number of failed attempts will be held by the controller 201, for example within a counter hidden memory area of the data storage device. When the number of failed attempts exceeds a preset number, then the controller 201 may cause the data storage device to be disabled and will prevent any further transmission of data. Any desired preset number may be selected. Where the validation algorithm set out above is used, the preset number is ten, that is ten attempts or tries are allowed before the data storage device is disabled.

As an alternative to disabling the data storage device, when the preset number of failed attempts is reached, the controller 201 may cause the data in the data store to be erased completely, so removing any potentially sensitive data or material from attempts at unauthorised access by other means. As a part of the same operation, the controller 201 may erase the PIN code stored within the hidden PIN data store 209, so effectively rendering the data storage device blank so that it can be reused. Where the PIN code controls access to only part of the data stored in the data storage device, then upon failure to provide the correct PIN code, the controller will disable access to or erase only the data associated with that PIN code.

As an alternative to disabling access to the data or erasing the data, the controller 201 may be programmed so as to prevent further communication between the data storage device and the reader by, for example, inhibiting operation of the modulator 202. The particular response of a particular data storage device to a reader exceeding the present number of attempts to provide the correct PIN code will depend upon the particular programming of the controller, the type of data storage device, for example, where the reuse is necessary or desirable, and the nature of the application in which the data storage device is being and/or the sensitivity of the data stored with the data storage device.

As described above, the hidden PIN data store 209 may store multiple PIN codes. Such multiple PIN codes can, as described above, be used to enhance the security level of the data storage device by programming the controller to require matching of multiple PIN codes rather than a single PIN code to be matched and, for example, programming the controller to require the successive PIN codes to be provided at given time intervals. Additionally, different PIN codes may enable access to different areas of the data store 207. A data storage device may also be programmed with a master PIN code, accessible only to an authorised user or reader, and which can be used to access disabled data storage devices or in the event that a user forgets a PIN code but still requires access to the data stored within the data storage device and can prove their authority to access that data. Also as set out above, a higher level of security may be required to change a PIN code and store a new PIN code within the hidden PIN data store 209 than to retrieve data from the data store, depending upon the relative sensitivity of the data. Thus, a hierarchy of PIN codes can be provided enabling a hierarchy of levels of access or security.

It will be evident from the above that there are many applications for a data storage device embodying the invention and that there are many different configurations and ways in which one or more hidden PIN codes can be used, depending upon the particular application. To illustrate this, a number of examples will be given. It should, however, be appreciated that these examples are not limiting and that there are many other examples of applications of data storage devices embodying the invention.

One example of an application of a data storage device embodying the invention is as a contactless memory stick which be easily transported, is cheap and which can be easily read by any suitable reader. In this application, it will be the end user or owner of the memory stick who wishes to control access to the data store by the data storage device and, in this case, the user will use his reader to insert a personal PIN code into the hidden PIN data store 209 so that only he and anyone else to whom he supplies the PIN code will be able to access the data held within the data storage device. In this example, the reader may be a handheld stand alone reader or may, for example, be incorporated into or associated with a personal computer, laptop, PDA or mobile telephone. Where the reader is incorporated into a mobile telephone or a PDA incorporating a mobile telephone functionality, then the user can use his mobile telephone or PDA to read the data storage device and control access to the data stored within the data storage device and may then for example download the data to a computer using a wireless or Bluetooth link.

It will be apparent that there are many ways in which reader functionality can as discussed above be incorporated into or interfaced with a larger device. FIGS. 7 and 8 show, respectively, a functional block diagram of such an interface and a flow chart illustrating operation of reader functionality within such a larger device.

As shown in FIG. 7, the reader 300 of FIG. 2 is provided by the reader functionality 900 which consists of a controller 905 controlling the reader functionality and a signal generator, modulator, driver and data receiver 901, 902, 903 and 904 corresponding to the signal generator, modulator, driver and data receiver 308, 302, 303 and 304 shown in FIG. 2. The reader functionality 900 also includes an inductive coupler or antenna 911 corresponding to the inductive coupler or antenna 311 shown in FIG. 2.

The controller 905 is coupled via an interface 907 to a host controller 908 which may be the microprocessor of the host larger device or an independent microprocessor within the larger device. In this example, the processing power required for the reader functionality is provided by the host controller 908. Accordingly, the reader controller 905 has more limited functionality and control than the controller 301 shown in FIG. 2. Thus, the reader controller 905 is programmed to carry out those functions or control protocols that are not carried out by the host microprocessor 908. For example, the controller 905 may control the timing of radio frequency communications, for example the timing of modulation and/or demodulation.

The interface 907 enables communication between the host controller 908, and reader controller 905 and provides any required translation or interpretation of the signals between the reader 900 and the host controller 908 so as to allow the larger device to communicate and interoperate with the reader. The interface 907 may form part of the reader 900 or may, as shown, be a separate component within the larger device.

A configuration store 906 is provided to allow for setting of parameters and protocols within the reader 900. As shown, the configuration store 900 communicates with the reader controller 905 via the interface 907. As another possibility, the configuration store may communicate directly with the parts of the reader 900 for which it stores configuration parameters or protocols, for example the modulator 902.

It will be appreciated that FIG. 7 does not show the functionality of the larger device that is not directly concerned with the interoperability with the reader 900. The larger device may be, for example, a mobile telephone or PDA and will have all the functional components of such a conventional larger device. In this case, the reader 900 may be a discrete integrated circuit within the mobile telephone, for example it may be incorporated into the fascia or another housing portion of the mobile telephone or may be provided within an accessory of the mobile telephone. As another possibility, the reader 900 may be incorporated in the mobile telephone circuit and be integral with the mobile telephone. The reader may have both data storage and reader functionality and may be, for example, an NFC device.

Operation of the reader 900 within such a larger device will now be described with reference to FIG. 8. In operation of a mobile telephone incorporating such a reader, assuming the reader within a mobile telephone is activated, it will transmit its RFID or NFC radio frequency signal and, once the mobile telephone comes into range of a data storage device at S81 in FIG. 8 then, at S82, the data storage device 200 will wake up as described above and send the appropriate response to the reader 900 within the mobile telephone. Communication between the reader 900 and the host controller 908 then causes the display of the mobile telephone to present to the user a message asking the user whether the user wishes to access data stored in a data storage device or to program a PIN code into the data storage device 200.

At S84, the reader waits for user input via the mobile telephone. In the event the user input indicates that the user just wants to access data, then at S91, the mobile telephone controller 908 communicates with the reader controller 905 to determine whether a PIN code is required to access the data. If the answer is no then, at S92, the communication between the host controller 908 and the reader controller 905 results in data being transferred. If however, the answer is yes, a PIN is required, then the host controller 908 and reader controller 905 will cooperate so that the steps shown in FIG. 5 or 6 are carried out. In the event the reader is unable to supply a correct PIN code, that is no predetermined relationship is detected at S70 in FIG. 6b then no data is transferred (S93 in FIG. 8). However, in the event that the reader in a mobile telephone is able to supply the correct PIN code then data is transferred as discussed above with reference to S611 and S612 in FIG. 5.

In the event at S84 that the host controller 905 determines that the user wishes to program a PIN code into the data storage device 200, then the user is prompted to type the desired PIN code into the mobile telephone at S85 and the host controller 908 and reader controller 905 then cooperate to cause the new PIN code to be transmitted to the data storage device 200. The reader controller 905 and host controller 908 then determine at S87 from the response of the data storage device whether or not an authentication PIN code is required. If no authentication PIN code is required (because there is currently no PIN stored in the hidden PIN data store 209), at S90 the data storage device controller 201 simply writes the new PIN code into the hidden PIN data store 209. If, however, an authentication PIN code is required, then the controller 201 of the data storage device modulates the received RF signal to request this authorisation PIN code and then carries out steps analogous to steps S46 to S49 in FIG. 3b and, assuming a predetermined relationship is determined, causes the new PIN code to be written in the hidden PIN data store 209 in the manner described above. As set out above, a number of attempts to enter the correct PIN code may be allowed. As described above, the reader may communicate with a third party or supplier which supplies the PIN code in response to, for example receipt of a payment or a user request.

In another example, a manufacturer may wish to control which readers access which data storage devices. Thus, for example, different readers may use different communication protocols and the manufacturer may wish to minimise or reduce any unintentional interoperation between readers and data storage devices which are designed to operate using different communications protocols, or to control access to different data storage devices.

A data storage device embodying the invention thus enables a manufacturer to manufacture a standard or generic data storage device and then or another party then to make that data storage device readable by storing only a particular reader or particular type of readers by storing a PIN code in the hidden PIN data store 209 in the manner described above. As an example, with a data storage device embodying the invention, a manufacturer will be able to manufacture a generic data storage device able to operate with different communications protocols and then the manufacturer, a supplier or distributor will be able to program that data storage device so that it can only operate under certain protocols by storing an appropriate PIN code in the hidden PIN data store 209. As another possibility, the data storage device may be set to the appropriate protocol on first use. For example, a data storage device may be manufactured having both ISO14443 type A and type B functionality. However, upon first use of the data storage device, a PIN code will be set in the hidden PIN data store 209 in accordance with whether the reader is type A or type B so that if the reader that first reads the data storage device is an ISO14443 type A reader, then the PIN code will be set which causes the data storage device subsequently to communicate only with ISO14443 type readers, that is the data storage device becomes an ISO14443 type A data storage device.

Controlling access to different data storage devices should avoid interference between different data storage devices and so enable different larger devices (for example a toaster and a kettle in a domestic environment) carrying data storage devices both to be in the range of the same reader but allow the reader only to communicate with the device carrying the data storage device with which the reader was designed or configured to operate, thereby minimizing interference between devices.

As another example, manufacturers of larger devices which comprise RFID or NFC reader functionality may wish to control access in some way to the data storage devices that can be read by the reader of that larger device. Thus, for example, manufacturers may wish to ensure that only approved data storage devices can be read. In such circumstances, the PIN code may be programmed into the data storage device by an approved supplier of such data storage devices, the PIN code itself being provided by the manufacturer of the larger device. As another possibility, it may be that certain conditions have to be fulfilled before a data storage device can be read, for example payment or request from an end user. An example of this is where the data storage device is incorporated in a poster so that when a reader within a portable user device such as a mobile telephone, MP3 player or similar audio file player or a PDA, comes into the range of the data storage device, a message appears on the display of the portable user device as a result of communication between the data storage device and the reader asking the portable user device user whether they would like to download the data from the data storage device carried by the poster. If the user wishes to download the data, then a service provider may supply the PIN code through the existing telecommunications network (SMS, GSM, 3G, MMS), via the Internet directly to the data storage device, or to the reader so that the reader of the portable user device can then communicate the correct PIN code to the data storage device, to enable, in each example, download of the data. In this example, the service provider may or may not charge the user for the access to the data.

As another example, data storage devices embodying the invention may be used to control access to certain secure or controlled areas or secure equipment within an establishment. In this case, an authorised user or an authorised security officer will have a reader or large device containing a reader that enables appropriate PIN codes to be programmed into data storage devices incorporated in passes or other articles designed to be carried by users so that access to the areas or equipment is determined by the PIN code stored in the users' data storage device. Similar principles can be applied to medical devices where data storage device embodying the invention can be programmed with PIN codes to control access to medicines or treatment systems so that only the use of the correct PIN code by an authorised nurse or doctor will allow treatment to go ahead or the drug to be discharged. A similar system could be used to allow patients to administer drugs at home, so restricting access to the patient themselves and preventing other members of the family from having access. In this example, the PIN code could comprise or be based on or derived from biometric data

The possibility described above of multiple PIN codes also allows for different charging or use conditions. As set out above, different PIN codes can be associated with different data access conditions. For example, one PIN code may grant access to all the data contents stored by a data storage device while a second PIN code may grant access to only a limited subset of the data or may grant access when certain conditions are met, for example payment for access privilege or download. Given the flexibility of data storage devices embodying the invention and the ability for end users to select there own PIN codes, it is also possible for those end users to control dissemination of data and/or access rights.

In the above described examples, the data storage devices embodying the invention are passive data storage devices which derive a power supply when they come into range of a suitable RF field. In some circumstances, data storage devices embodying the invention may be “active”, that is the power deriver shown in FIG. 1 may be replaced by an internal power source in the form of, generally, a battery. In this case, of course, the line 211 shown in FIG. 1 will be omitted.

As described above, data storage devices embodying the invention communicate with a reader in range of the data storage device by modulating the RF signal supplied by the reader. This need not necessarily be the case and the data storage device itself may include a signal generator or oscillator so that the data storage device can generate its own RF signal which can then be modulated by the modulator 202 as described above.

References in this application to “a data storage device” or “data storage devices” and to “a reader” or “readers” should be taken to include any device, apparatus or equipment having the functionality described above for such a data storage device or reader.

1-22. (canceled)

23. A communications system comprising: a data storage device comprising a store storing data; and a portable user device configured to communicate over a telecommunications network and incorporating a reader configured to communicate wirelessly with the data storage device when the portable communications device comes within range of the data storage device to cause a user interface of the portable user device to issue a message to the user asking whether or not the user wishes to download data from the data storage device,
the portable user device being configured to provide identification data when the user indicates that they wish to download the data and the reader being configured to communicate a signal comprising the identification data wirelessly to the data storage device, and
the data storage device having an identification data storer storing identification data, an extractor operable to extract identification data from a signal received from the reader, a comparator operable to compare the extracted identification data with identification data stored in the identification data store of the data storage device and a controller operable to download data stored in the store to the reader of the portable user device in the event the extracted identification data enables downloading of that data.

24. A system according to claim 23, wherein the identification data store comprises a write only memory portion.

25. A system according to claim 23, further comprising:
an enabler operable to enable writing of identification data communicated to the data storage device by the reader to the identification data store.

26. A system according to claim 25, wherein the enabler is operable to enable writing of identification data to the identification data store in at least one of the following circumstances: 1) there is no identification data stored in the identification data store; and 2) in accordance with the outcome of the comparison carried out by the comparator.

27. A system according to claim 23, wherein the controller is operable, in accordance with the result of a comparison by the comparator of obtained identification data with stored identification data, to enable the user of the portable user device to change or supplement the identification data stored by the identification data store to control the readers that can read data from the data storage device.

28. A system according to claim 23, wherein the identification data store is configured to be writable to only once for storing identification data.

29. A system according to claim 23, wherein the identification data comprises at least one PIN code.

30. A system according to claim 29, wherein the extractor is operable to extract a plurality of PIN codes, the comparator is operable to compare a plurality of PIN codes and the controller is operable to control operation of the data storage device in accordance with the outcome of the comparisons carried out by the comparator.

31. A system according to claim 23, wherein the identification data store comprises a plurality of storage portions, each storage portion being associated with different identification data, and wherein the data storage device is operable to permit access to each storage portion of the identification data store on the basis of corresponding identification data extracted by the extractor so as to control operation of the data storage device.

32. A system according to claim 23, wherein the controller further comprises a determiner operable to determine the number of times the identification data communicated to the data storage device does not have a predefined relationship with identification data stored by the identification data store.

33. A system according to claim 31, wherein the controller further comprises a locker operable to lock the data storage device in a disabled state in the event that the number of times the identification data communicated to the data storage device does not have a predefined relationship with identification data stored by the identification data store reaches a predetermined number.

34. A system according to claim 33, wherein the controller is arranged to unlock the data storage device from a disabled state in the event predetermined identification information is communicated to the data storage device.

35. A system according to claim 32, wherein the controller further comprises an eraser operable to erase at least some of the data stored by the store in the event the determined number reaches a set number.

36. A system according to claim 23, wherein the data storage device further comprises a power supply deriver operable to derive a power supply from a reader signal to enable operation of the data storage device.

37. A system according to claim 23, wherein the data storage device is operable to communicate data to a reader by modulating the reader signal.

38. A system according to claim 23, wherein the data storage device and reader are configured to communicate by radio frequency communication and primarily by inductive coupling.

39. A system according to claim 23, wherein the portable user device is configured to communicate with a service provider via the telecommunications network to obtain the identification data when the user indicates that they wish to download the data.

40. A data storage device configured to cooperate with a portable user device that can communicate over a telecommunications network, the data storage device being configured to communicate wirelessly with a reader of the portable storage device when the portable communications device comes within range of the data storage device to cause a user interface of the portable user device to issue a message to the user asking whether or not the user wishes to download data from the data storage device and to receive from the reader a signal comprising identification data provided by the portable user device when the user indicates that they wish to download the data,
the data storage device having an identification data store storing identification data, an extractor operable to extract identification data provided by the portable user device from a signal received from the reader, a comparator operable to compare the extracted identification data with identification data stored in the identification data store of the data storage device and a controller operable to download data stored in the store to the reader of the portable user device in the event the extracted identification data enables downloading of that data.

41. A data storage device for wirelessly communicating with a reader of a portable user device to enable data to be read from the data storage device, the device comprising:
a communicator operable to enable wireless communication with a reader to enable receipt of a reader signal and to enable communication of data between the device and the reader,
wherein the device is initially arranged to communicate with different readers and, in response to receipt of a reader signal from a particular reader or readers, is subsequently arranged to communicate with that reader or those readers.

42. A device according to claim 41, wherein the reader signal comprises identification data that enables a user of the portable user device to control the readers that can read data from the data storage device.

43. A communications system comprising: a data storage device comprising storage means storing data; and a portable user device configured to communicate over a telecommunications network and incorporating a reader configured to communicate wirelessly with the data storage device when the portable communications device comes within range of the data storage device to cause a user interface of the portable user device to issue a message to the user asking whether or not the user wishes to download data from the data storage device,
the portable user device being configured to provide identification data when the user indicates that they wish to download the data and the reader being configured to communicate a signal comprising the identification data wirelessly to the data storage device, and
the data storage device having identification data storage means storing identification data, extracting means for extracting identification data from a signal received from the reader, comparison means for comparing the extracted identification data with identification data stored in the identification data storage means of the data storage device and control means for downloading data stored in the storage means to the reader of the portable user device in the event the extracted identification data enables downloading of that data.
